(19) United States
(12) Patent Application Publication
(10) Pub. No.: US 2017/0019739 A1
(43) Pub. Date: Jan. 19, 2017

(54) Hearing Aid with Adjustable Ear Mount

(71) Applicants: Yong D. Zhao, Simi Valley, CA (US); Jennifer Jinping Zhao, Simi Valley, CA (US)

(72) Inventors: Yong D. Zhao, Simi Valley, CA (US); Jennifer Jinping Zhao, Simi Valley, CA (US)

(21) Appl. No.: 14/797,210

(22) Filed: Jul. 13, 2015

(51) Int. Cl. H04R 25/00; H04R 1/10

(52) U.S. Cl. CPC H04R 25/55; H04R 1/1008; H04R 1/105; H04R 2225/021

(57) ABSTRACT

A hearing aid with adjustable ear mount is an apparatus which assists users in hearing sounds that they are otherwise unable to hear. The hearing aid with adjustable ear mount includes a hearing aid control unit which detects sound, and sends a digital representation of the sound to a speaker through at least one electrical wire. At least one pliable wire is also connected between the hearing aid control unit and the speaker and can be shaped to properly fit around ears of various shapes and sizes. A flexible tube covers the at least one electrical wire and the at least one pliable wire for protection and added comfort. An earpiece is connected to the speaker and helps to secure the speaker in a position that directs sound into the user's ear canal. The earpiece is designed to fit ears of various shapes and sizes.

### FIELD OF THE INVENTION

The present invention relates generally to hearing aids. More specifically, the present invention relates to a new and useful hearing aid with an adjustable mount which may be used by people with ears of many shapes and sizes. The present invention uses a pliable wire which may be bent, stretched or adjusted to provide a comfortable fit for the user. The earpiece of the present invention can also fit inside ear canals of varying sizes.

### BACKGROUND OF THE INVENTION

Hearing aids are commonly used to assist people with hearing impairments or disabilities to hear sounds which they would otherwise be unable to hear. Common hearing aids are often sized or shaped to specifically fit the ear of the user. This level of customization is effective when providing a comfortable fit, but increases the price of the hearing aid and limits the potential use of the hearing aid. Because the hearing aid may be specifically sized to fit one of the user's ears, the hearing aid would likely not comfortably fit in the user's other ear. Moreover, the hearing aid would not likely fit into the ear of another user. Often, the wire that connects the ear piece with the rest of the hearing aid is either rigid, lacks definition, or cannot be adjusted in length. This can be especially inconvenient for children who are growing.

Accordingly, there is a present need for an improved hearing aid that is capable of comfortably fitting ears of various shapes and sizes. The present invention is a hearing aid with an adjustable ear mount which can fit around and inside ears of various sizes. A pliable wire allows the present invention to be bent into a shape that comfortably fits over the user's ear. The effective length of the pliable wire may also be adjusted by pulling or stretching or reshaping the pliable wire in reference to hearing aid control unit. The earpiece of the hearing aid may deform such that the earpiece comfortably fits inside ear canals of different shapes and sizes.

### BRIEF DESCRIPTION OF THE DRAWINGS

FIG. 1 is a top left perspective view of the present invention.

FIG. 2 is a top right perspective view of the present invention.

FIG. 3 is a top left perspective view of the electrical wire, the pliable wire, and the flexible tube, wherein the flexible tube is shown in dashed lines.

FIG. 4 is a left side view of the present invention.

FIG. 5 is a front view of the present invention.

FIG. 6 is cross-sectional schematic view of the electrical wire, the pliable wire, and the flexible tube, wherein the at least one lumen is a single lumen.

FIG. 7 is cross-sectional schematic view of the electrical wire, the pliable wire, and the flexible tube, wherein the at least one lumen is a plurality of lumens.

FIG. 8 is cross-sectional schematic view of the electrical wire, the pliable wire, and the flexible tube, wherein the at least one lumen is a plurality of lumens.

FIG. 9 is a front view of the present invention, wherein the hearing aid control unit is shown in dashed lines.

FIG. 10 is a top left perspective view of the electrical wire, the pliable wire, and the flexible tube, wherein the flexible tube and the plurality of wire gaps are shown in dashed lines.

FIG. 11 is a top left perspective view of the present invention, wherein the plurality of tube gaps is shown in dashed lines.

### DETAILED DESCRIPTION OF THE INVENTION

All illustrations of the drawings are for the purpose of describing selected versions of the present invention and are not intended to limit the scope of the present invention.

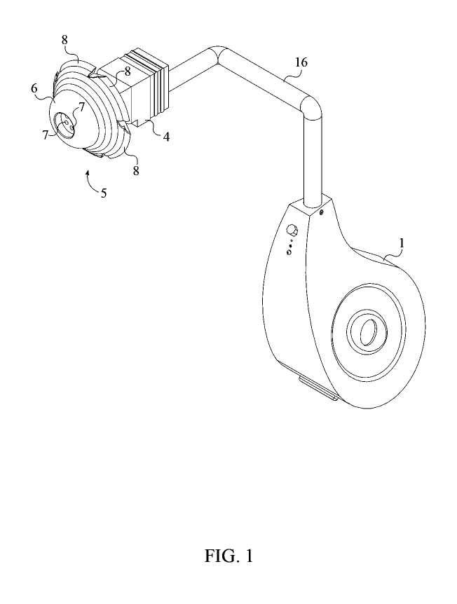

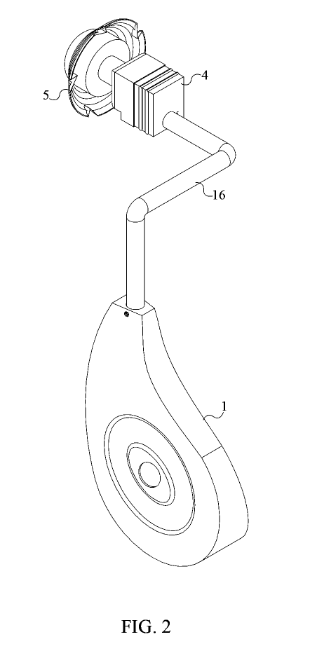

With reference to FIGS. 1-3 the present invention is a hearing aid with an adjustable ear mount that is used to amplify sounds such that they may be heard by people with disabilities or who are hard of hearing. The present invention may be easily adjusted to fit over various ear shapes and includes an earpiece 5 which may be comfortably inserted into the left or right ear of the user. The present invention comprises a hearing aid control unit 1, a speaker 4, an earpiece 5, at least one electrical wire 10, at least one pliable wire 11, and a flexible tube 16. The speaker 4 and the hearing aid control unit 1 are electrically connected to each other through the at least one electrical wire 10. The hearing aid control unit 1 is used to detect sounds and adjust how the user hears sounds. Various components may be contained within the hearing aid control unit 1 including, but not limited to, a microphone, a battery, an amplifier, and one or more control switches. Sound which is detected by the hearing aid control unit 1 is sent to the speaker 4, through the at least one electrical wire 10. The speaker 4 is used to convert digital information from the hearing aid control unit 1 into amplified sound which can be heard by the user. The at least one pliable wire 11 fits over the user's ear and may be bent or stretched into a shape that is comfortable for the user. The at least one pliable wire 11 comprises a first wire end 12 and a second wire end 13. The first wire end 12 is connected adjacent to the speaker 4 and the second wire end 13 is telescopically mounted into the hearing aid control unit 1. This configuration allows the user to bend or adjust the pliable wire 11 such that the speaker 4 may be comfortably positioned adjacent to the user's ear canal. The earpiece 5 is connected adjacent to the speaker 4, opposite to the flexible tube 16. The earpiece 5 is used to situate the speaker 4 in a position that directs sound towards the user's ear canal.

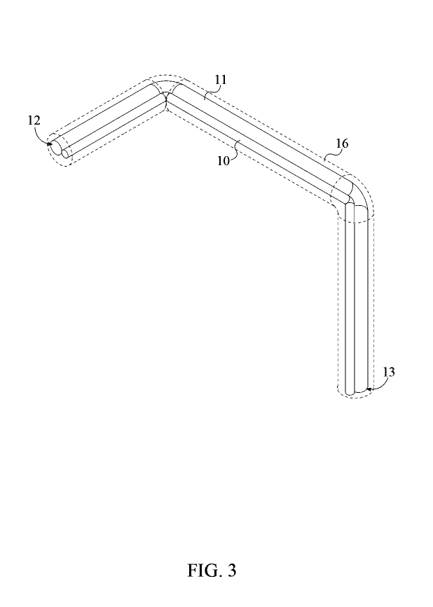

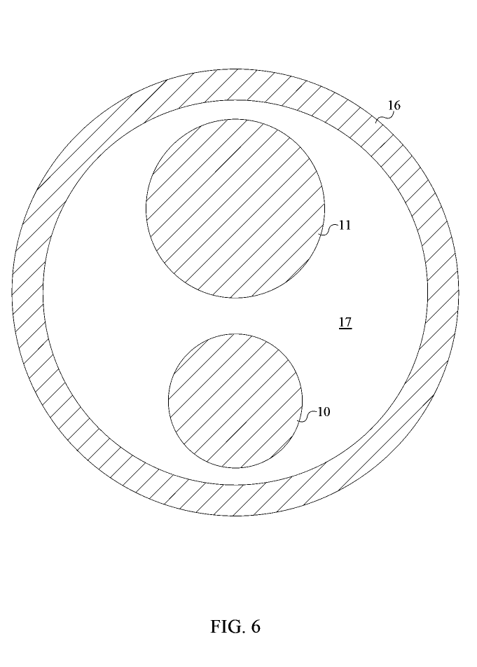

In reference to FIG. 3 and FIG. 6, the flexible tube 16 is used as a protective cover for the at least one electrical wire 10 and the at least one pliable wire 11. The at least one electrical wire 10 and the at least one pliable wire 11 are laterally enclosed by the flexible tube 16. The flexible tube 16 also helps to provide a comfortable fit over the user's ear. The flexible tube 16 comprises at least one lumen 17. The at least one lumen 17 traverses through and along the flexible tube 16 and creates an elongated chamber through which wires can run. The at least one electrical wire 10 and the at least one pliable wire 11 are positioned within the at least one lumen 17. For embodiments of the present invention where the at least one lumen 17 comprises more than one lumen, individual lumens may be used to separate the at least one electrical wire 10 and the at least one pliable wire 11.

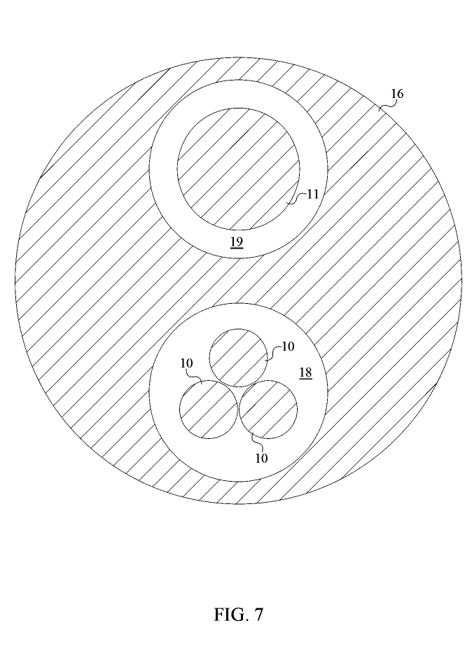

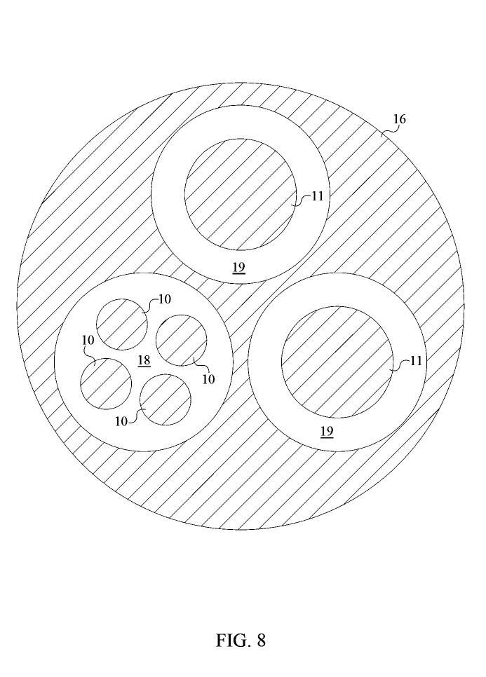

In a first embodiment of the present invention, the at least one lumen 17 is a single lumen. This is shown in FIG. 6. In this situation, the at least one electrical wire 10 and the at least one pliable wire 11 are positioned within the single lumen. In an alternative embodiment of the present invention, the at least one lumen 17 is a plurality of lumens. This is shown in FIGS. 7-8. The plurality of lumens comprises at least one electrical lumen 18 and at least one pliable lumen 19. The at least one electrical wire 10 is positioned within the at least one electrical lumen 18 and the at least one pliable wire 11 is positioned within the at least one pliable lumen 19. In this embodiment, if the at least one electrical wire 10 comprises more than one electrical wire 10, each of the electrical wires 10 may be positioned within a single electrical lumen 18 or may each be positioned within separate electrical lumens 18 if the at least one electrical lumen 18 comprises more than one electrical lumen 18. Similarly, if the at least one pliable wire 11 comprises more than one pliable wire 11, each of the pliable wires 11 may be positioned within a single pliable lumen 19 or may each be positioned within separate pliable lumens 19 if the at least one pliable lumen 19 comprises more than one pliable lumen 19. For this configuration, the at least one electrical lumen 18 and the at least one pliable lumen 19 may act to insulate wires which need to be separated and or protected. Furthermore, both the at least one electrical wire 10 and the at least one pliable wire 11 may be covered in an insulation material to prevent the at least one electrical wire 10 from shorting.

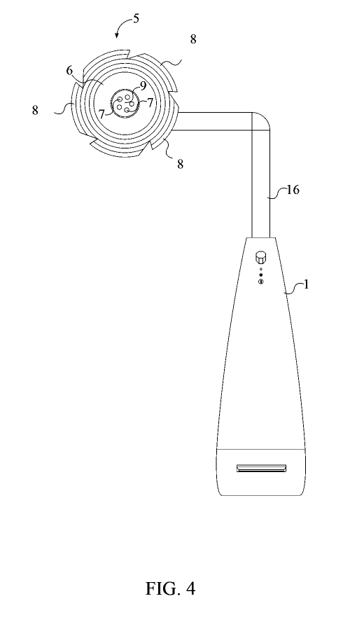

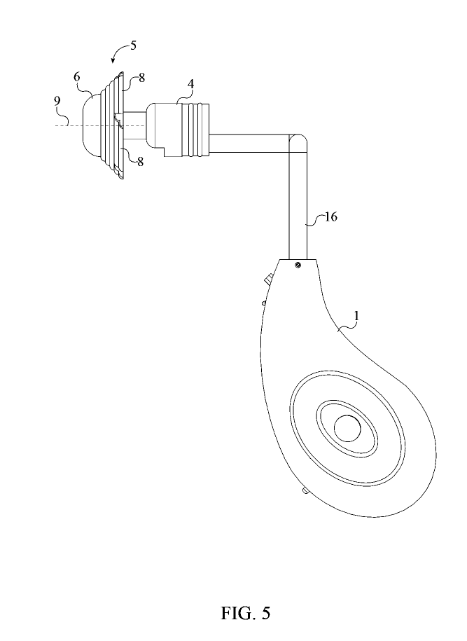

In reference to FIGS. 4-5, the earpiece 5 comprises a main body 6, a plurality of audio holes 7, and a plurality of angled spring members 8. The main body 6 makes up the majority of the earpiece 5 and is the structural portion of the earpiece 5 that connects to the speaker 4. A central axis 9 of the earpiece 5 is positioned normal to the speaker 4 and symmetrically traverses through the main body 6. The plurality of audio holes 7 traverses through the main body 6, parallel to the central axis 9, and allows sound to pass through the main body 6 without being distorted or muffled by the main body 6. The plurality of angled spring members 8 is radially connected to the main body 6, adjacent to the speaker 4. The plurality of angled spring members 8 is also radially positioned about the central axis 9 of the earpiece 5. Consequently, the plurality of angled spring members 8 is able to deform as the earpiece 5 is inserted into the user's ear. Because the plurality of angled spring members 8 is able to deform, the earpiece 5 may be placed comfortably in ears of different shapes and sizes.

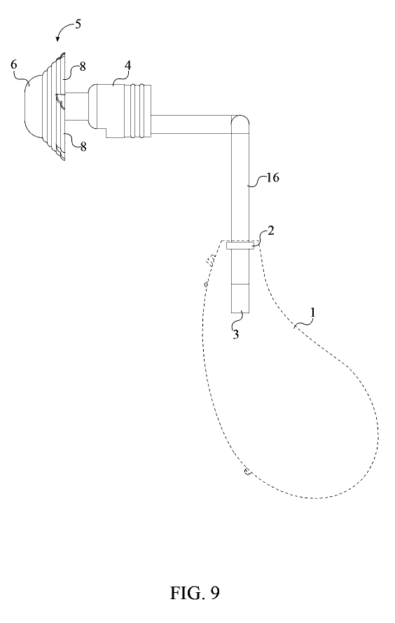

In reference to FIG. 9, the hearing aid control unit 1 comprises a clamp 2 and a wire-receiving cavity 3. The wire-receiving cavity 3 traverses into the hearing aid control unit 1. The second wire end 13 is slidably engaged into the wire-receiving cavity 3. This configuration allows an additional length of wire to be pulled such that the earpiece 5 may be moved further away from the hearing aid control unit 1. This is especially useful for users with relatively large ears. The clamp 2 is mechanically integrated into the hearing aid control unit 1, adjacent to the wire-receiving cavity 3. The clamp 2 is used to secure the position of the second wire end 13 at a distance along the wire-receiving cavity 3 which best suits the user. If the user has small ears, the second wire end 13 may traverse further into wire-receiving cavity 3. Alternatively, if the user has large ears, the second wire end 13 may be moved outward along the wire-receiving cavity 3.

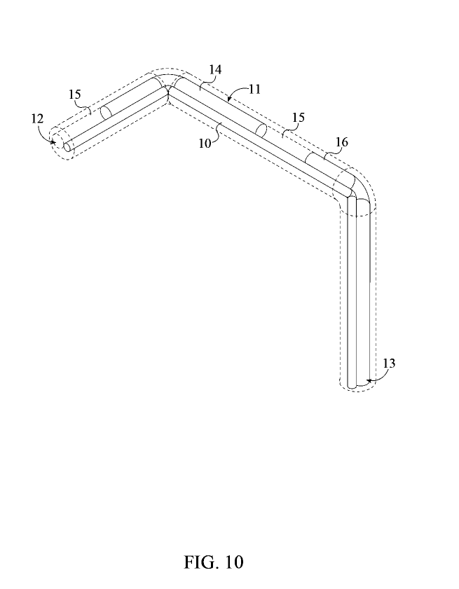

In one embodiment of the present invention, the at least one pliable wire 11 comprises a wire body 14 and a plurality of wire gaps 15. This is shown in FIG. 10. Though the at least one pliable wire 11 may be bent or adjusted to comfortably fit around the user's ear, the plurality of wire gaps 15 allows for added maneuverability. Each of the plurality of wire gaps 15 laterally traverses through the wire body 14. In the location of the plurality of wire gaps 15, the flexible tube 16 and the at least one electrical wire 10 are able to be bent more easily. Accordingly, the plurality of wire gaps 15 is distributed along the wire body 14 such that the present invention may easily be stored when not in use.

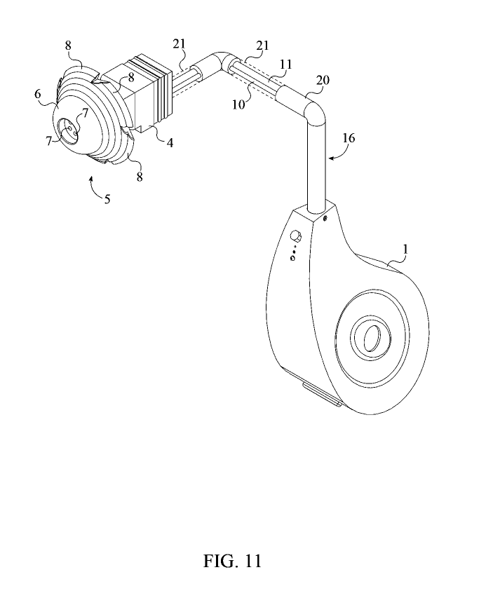

Similar to the at least one pliable wire 11, the flexible tube 16 comprises a tube body 20 and a plurality of tube gaps 21. This is shown in FIG. 11. Each of the plurality of tube gaps 21 laterally traverses through the tube body 20 such that the at least one pliable wire 11 and the at least one electrical wire 10 may be more easily bent or otherwise maneuvered. The plurality of tube gaps 21 is distributed along the tube body 20. The plurality of tube gaps 21 may be positioned in areas which do not normally contact the user's skin, thus removing excess bulk.

Although the invention has been explained in relation to its preferred embodiment, it is to be understood that many other possible modifications and variations can be made without departing from the spirit and scope of the invention as hereinafter claimed.

What is claimed is:

1. A hearing aid with adaptable ear mount comprises:
a hearing aid control unit;
a speaker;
an earpiece;
at least one electrical wire;
at least one pliable wire;
a flexible tube;
the at least one pliable wire comprises a first wire end and a second wire end;
the speaker and the hearing aid control unit being electrically connected to each other through the at least one electrical wire;
the first wire end being connected adjacent to the speaker;
the second wire end being telescopically mounted into the hearing aid control unit;
the at least one electrical wire and the at least one pliable wire being laterally enclosed by the flexible tube; and
the earpiece being connected adjacent to the speaker, opposite to the flexible tube.

2. The hearing aid with adaptable ear mount as claimed in claim 1 comprises:
the flexible tube comprises at least one lumen;
the at least one lumen traversing through and along the flexible tube; and
the at least one electrical wire and the at least one pliable wire being positioned within the at least one lumen.

3. The hearing aid with adaptable ear mount as claimed in claim 2 comprises:
the at least one lumen being a single lumen; and
the at least one electrical wire and the at least one pliable wire being positioned within the single lumen.

4. The hearing aid with adaptable ear mount as claimed in claim 2 comprises:
the at least one lumen being a plurality of lumens;
the plurality of lumens comprises at least one electrical lumen and at least one pliable lumen;
the at least one electrical wire being positioned within the at least one electrical lumen; and
the at least one pliable wire being positioned within the at least one pliable lumen.

5. The hearing aid with adaptable ear mount as claimed in claim 1 comprises:
the earpiece comprises a main body, a plurality of audio holes, and a plurality of angled spring members;
a central axis of the earpiece being positioned normal to the speaker;
the central axis symmetrically traversing through the main body;
the plurality of audio holes traversing through the main body, parallel to the central axis;
the plurality of angled spring members being laterally connected to the main body, adjacent to the speaker; and
the plurality of angled spring members being radially positioned about the central axis of the earpiece.

6. The hearing aid with adaptable ear mount as claimed in claim 1 comprises:
the hearing aid control unit comprises a clamp and a wire-receiving cavity;
the wire-receiving cavity traversing into the hearing aid control unit;
the second wire end being slidably engaged into the wire-receiving cavity; and
the clamp being mechanically integrated into the hearing aid control unit, adjacent to the wire-receiving cavity.

7. The hearing aid with adaptable ear mount as claimed in claim 1 comprises:
the at least one pliable wire comprises a wire body and a plurality of wire gaps;
each of plurality of wire gaps laterally traversing through the wire body; and
the plurality of wire gaps being distributed along the wire body.

8. The hearing aid with adaptable ear mount as claimed in claim 1 comprises:
the flexible tube comprises a tube body and a plurality of tube gaps;
each of plurality of tube gaps laterally traversing through the tube body; and
the plurality of tube gaps being distributed along the tube body.

9. A hearing aid with adaptable ear mount comprises:
a hearing aid control unit;
a speaker;
an earpiece;
at least one electrical wire;
at least one pliable wire;
a flexible tube;
the at least one pliable wire comprises a first wire end and a second wire end;
the earpiece comprises a main body, a plurality of audio holes, and a plurality of angled spring members;
the speaker and the hearing aid control unit being electrically connected to each other through the at least one electrical wire;
the first wire end being connected adjacent to the speaker;
the second wire end being telescopically mounted into the hearing aid control unit;
the at least one electrical wire and the at least one pliable wire being laterally enclosed by the flexible tube;
the earpiece being connected adjacent to the speaker, opposite to the flexible tube.
a central axis of the earpiece being positioned normal to the speaker;
the central axis symmetrically traversing through the main body;
the plurality of audio holes traversing through the main body, parallel to the central axis;
the plurality of angled spring members being laterally connected to the main body, adjacent to the speaker; and
the plurality of angled spring members being radially positioned about the central axis of the earpiece.

10. The hearing aid with adaptable ear mount as claimed in claim 9 comprises:
the flexible tube comprises at least one lumen;
the at least one lumen traversing through and along the flexible tube; and
the at least one electrical wire and the at least one pliable wire being positioned within the at least one lumen.

11. The hearing aid with adaptable ear mount as claimed in claim 10 comprises:
the at least one lumen being a single lumen; and
the at least one electrical wire and the at least one pliable wire being positioned within the single lumen.

12. The hearing aid with adaptable ear mount as claimed in claim 10 comprises:
the at least one lumen being a plurality of lumens;
the plurality of lumens comprises at least one electrical lumen and at least one pliable lumen;
the at least one electrical wire being positioned within the at least one electrical lumen; and
the at least one pliable wire being positioned within the at least one pliable lumen.

13. The hearing aid with adaptable ear mount as claimed in claim 9 comprises:
the hearing aid control unit comprises a clamp and a wire-receiving cavity;
the wire-receiving cavity traversing into the hearing aid control unit;
the second wire end being slidably engaged into the wire-receiving cavity; and
the clamp being mechanically integrated into the hearing aid control unit, adjacent to the wire-receiving cavity.

14. The hearing aid with adaptable ear mount as claimed in claim 9 comprises:
the at least one pliable wire comprises a wire body and a plurality of wire gaps;
the flexible tube comprises a tube body and a plurality of tube gaps;
each of plurality of wire gaps laterally traversing through the wire body;
the plurality of wire gaps being distributed along the wire body;
each of plurality of tube gaps laterally traversing through the tube body; and
the plurality of tube gaps being distributed along the tube body.

15. A hearing aid with adaptable ear mount comprises:
a hearing aid control unit;
a speaker;
an earpiece;
at least one electrical wire;
at least one pliable wire;
a flexible tube;
the at least one pliable wire comprises a first wire end and a second wire end;
the hearing aid control unit comprises a clamp and a wire-receiving cavity;
the speaker and the hearing aid control unit being electrically connected to each other through the at least one electrical wire;
the first wire end being connected adjacent to the speaker;
the second wire end being telescopically mounted into the hearing aid control unit;
the at least one electrical wire and the at least one pliable wire being laterally enclosed by the flexible tube;
the earpiece being connected adjacent to the speaker, opposite to the flexible tube. the wire-receiving cavity traversing into the hearing aid control unit;
the second wire end being slidably engaged into the wire-receiving cavity; and
the clamp being mechanically integrated into the hearing aid control unit, adjacent to the wire-receiving cavity.

16. The hearing aid with adaptable ear mount as claimed in claim 15 comprises:
the flexible tube comprises at least one lumen;
the at least one lumen traversing through and along the flexible tube; and
the at least one electrical wire and the at least one pliable wire being positioned within the at least one lumen.

17. The hearing aid with adaptable ear mount as claimed in claim 16 comprises:
the at least one lumen being a single lumen; and
the at least one electrical wire and the at least one pliable wire being positioned within the single lumen.

18. The hearing aid with adaptable ear mount as claimed in claim 16 comprises:
the at least one lumen being a plurality of lumens;
the plurality of lumens comprises at least one electrical lumen and at least one pliable lumen;
the at least one electrical wire being positioned within the at least one electrical lumen; and
the at least one pliable wire being positioned within the at least one pliable lumen.

19. The hearing aid with adaptable ear mount as claimed in claim 15 comprises:
the earpiece comprises a main body, a plurality of audio holes, and a plurality of angled spring members;
a central axis of the earpiece being positioned normal to the speaker;
the central axis symmetrically traversing through the main body;
the plurality of audio holes traversing through the main body, parallel to the central axis;
the plurality of angled spring members being laterally connected to the main body, adjacent to the speaker; and
the plurality of angled spring members being radially positioned about the central axis of the earpiece.

20. The hearing aid with adaptable ear mount as claimed in claim 15 comprises:
the at least one pliable wire comprises a wire body and a plurality of wire gaps;
the flexible tube comprises a tube body and a plurality of tube gaps;
each of plurality of wire gaps laterally traversing through the wire body;
the plurality of wire gaps being distributed along the wire body;
each of plurality of tube gaps laterally traversing through the tube body; and
the plurality of tube gaps being distributed along the tube body.
